(19) United States
(12) Patent Application Publication
(10) Pub. No.: US 2014/0297910 A1
(43) Pub. Date: Oct. 2, 2014

(54) SAS EXPANDER

(71) Applicant: Hewlett-Packard Development Company, L.P., Houston, TX (US)

(72) Inventors: Joseph David Black, Houston, TX (US); Balaji Natrajan, Spring, TX (US); Michael G. Myrah, Sammamish, WA (US)

(21) Appl. No.: 13/853,873

(22) Filed: Mar. 29, 2013

(51) Int. Cl. G06F 13/42

(52) U.S. Cl. CPC G06F 13/4265
USPC 710/104

(57) ABSTRACT

A SAS expander that includes a storage management module to cause the SAS expander to configure zoning of targets coupled to the SAS expander based on zone configuration rules. The storage management to cause, in response to receipt of a command to enter an expander reduced functionality mode of operation, the SAS expander to prevent initiators access to the targets coupled to the SAS expander and to allow update of expander functionality module for controlling operation of the SAS expander. The storage management module to cause, upon completion of the expander reduced functionality mode of operation, the SAS expander to reconfigure the zoning of the targets coupled to the SAS expander based on the zone configuration rules and to allow initiators access to the targets coupled to the SAS expander.

### BACKGROUND

Serial attached SCSI (SAS) is generally a point-to-point architecture that transfers data to and from small computer system interface (SCSI) storage devices by using serial communication. In a SAS storage environment, there are typically three types of SAS devices: initiator devices, targets, and expanders. The initiator is generally a device that originates processing requests for a target and receives responses from the target. The initiator may be, for example, a host bus adapter (HBA), SAS controller, or other data storage controllers. The target is generally a device that receives processing requests from initiators and sends responses to the respective initiators. The target may be, for example, an end device such as a SAS hard disk drive, serial ATA (SATA) hard disk drive, solid state disk (SSD), JBOD, and/or SAS tape drive. The expander is generally an intermediate device that forms part of the service delivery subsystem and facilitates communication between initiators, targets, and/or other expanders, among other functions. Stated differently, the expander is a device that functions as a switch and scales the number of targets attached to an initiator, thereby creating a larger SAS domain.

### BRIEF DESCRIPTION OF THE DRAWINGS

Examples are described in the following detailed description and in reference to the drawings, in which:

FIG. 1 depicts an example system comprising an expander in accordance with an example of the techniques of present application;

FIG. 2 depicts an example flow chart of processes conducted by an expander in accordance with an example of the techniques of present application; and

FIG. 3 depicts an example block diagram showing a non-transitory, computer-readable medium that stores instructions for operating an expander in accordance with an example of the techniques of the present application.

### DETAILED DESCRIPTION

As explained above, Serial attached SCSI (SAS) is generally a point-to-point architecture that transfers data to and from small computer system interface (SCSI) storage devices by using serial communication. In a SAS storage environment, there are typically three types of SAS devices: initiator devices, targets, and expanders. The initiator is generally a device that originates processing requests for a target and receives responses from the target. The initiator may be, for example, a host bus adapter (HBA), SAS controller, or other data storage controllers. The target is generally a device that receives processing requests from initiators and sends responses to the respective initiators. The target may be, for example, an end device such as a SAS hard disk drive, serial ATA (SATA) hard disk drive, solid state disk (SSD). JBOD, and/or SAS tape drive. The expander is generally an intermediate device that forms part of the service delivery subsystem and facilitates communication between initiators, targets, and/or other expanders, among other functions. Stated differently, the expander is a device that functions as a switch and scales the number of targets attached to an initiator, thereby creating a larger SAS domain

As mentioned in the foregoing, an expander is generally an intermediate device that forms part of the service delivery subsystem and facilitates communication between initiators, targets, and/or other expanders. More specifically, the expander may establish connections between initiators, targets, and/or other expanders by receiving commands and routing these commands and/or data associated therewith based on the SAS address of the target.

The expander may include an expander functionality module which may include firmware for controlling operation of the expander. There may be instances where it may be desirable to update the expander functionality module of the expander. The SAS Protocol Layer (SPL) specification Revision 07, section 4.6.8 describes a feature called expander device reduced functionality. When an expander supports the expander reduced functionality mode, it is possible for an initiator to update the functionality module of the expander, and then cause the expander to reset or reboot which may leave the ports of the expander operational. This feature effectively allows for non-disruptive update of the functionality module of an expander and other devices. However, once the expander completes or exits the expander reduced functionality mode, it may be possible for multiple initiators to gain unauthorized access to targets such as storage devices and corrupt storage drive meta data and other data, potentially causing data loss. For example, in a zoning environment where multiple initiators share access to a storage enclosure with targets having storage devices, there may be a window of time where previous zoning configuration rules can be violated because the expander may not automatically reapply or reconfigure the zoning configuration rules after exiting the reduced functionality mode. This may cause data corruption or data loss if the initiators are modifying data on storage drives they are not authorized to access. That is, the process for updating the expander functionality module of an expander may disrupt the zoning of targets coupled to the expander such that initiators may gain unauthorized access to targets.

Various aspects of the present application may address the above-mentioned problems by disclosing techniques to implement expander reduced functionality mode and allow dynamic zoning of targets to initiators but prevent initiators from accessing the targets coupled to the expander when the expander functionality module of the expander is updated.

In one aspect of the present application, disclosed is a SAS expander that includes a storage management module configured to cause the SAS expander to configure zoning of targets coupled to the SAS expander based on zone configuration rules. The storage management module is configured to cause, in response to receipt of a command to enter an expander reduced functionality mode of operation, the SAS expander to prevent initiators access to the targets coupled to the SAS expander and to allow update of expander functionality module for controlling operation of the SAS expander. The storage management module is configured to cause, upon completion of the expander reduced functionality mode of operation, the SAS expander to reconfigure the zoning of the targets coupled to the SAS expander based on the zone configuration rules and to allow initiators access to the targets coupled to the SAS expander.

In this manner, the present application provides techniques to implement expander reduced functionality mode and allow dynamic zoning of targets to initiators but prevent initiators from accessing the targets coupled to the expander when the expander functionality module of the expander is updated.

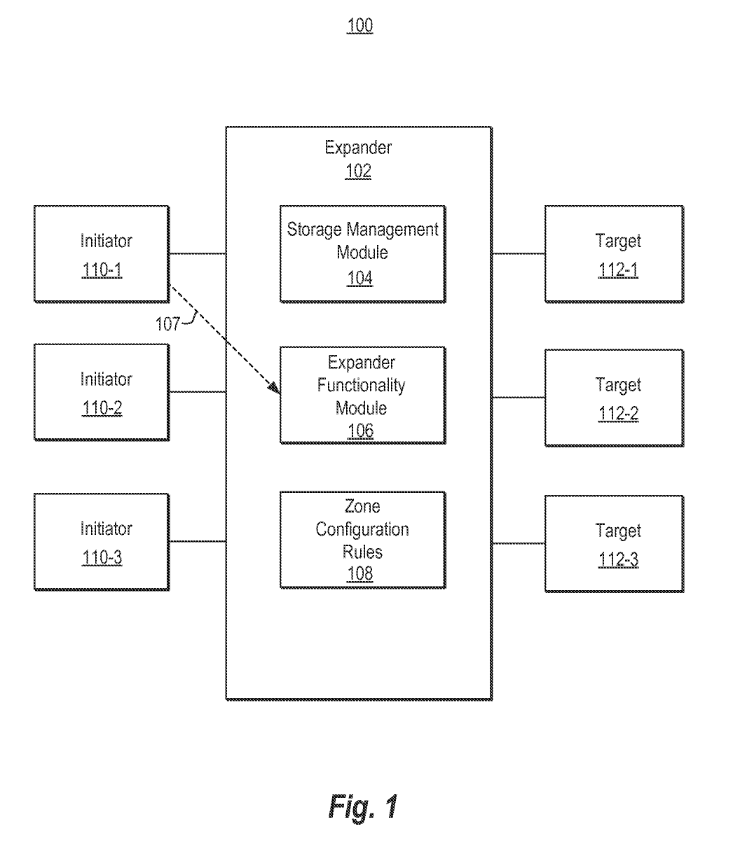

FIG. 1 depicts an example system 100 comprising an expander in accordance with an example of the techniques of present application. The system 100 comprises a plurality of initiators 110 (110-1 through 110-3), an expander 102, and a plurality of targets 112 (112-1 through 112-3). The system 100 comprises a SAS fabric or network of SAS devices including expander 102, initiators 110 and targets 112 interconnected to communicate using SAS based protocols. It should be readily apparent that the system 100 is a generalized illustration and that other elements may be added or existing elements may be removed, modified, or rearranged without departing from the scope of the present application. For example, while the system 100 depicted in FIG. 1 includes only three targets 112, the system may actually comprise more or less targets or other components. Similarly, while the system 100 depicted in FIG. 1 includes three initiators 110, the system 100 may actually comprise a plurality of such components. Likewise, while the system 100 depicted in FIG. 1 includes one expander 102, the system 100 may actually comprise a plurality of such components, and only one has been shown for brevity.

The initiators 110 may be, for example, host bus adapters (HBAs), SAS controllers, or other types of data storage controllers. The initiators 110 may have multiple ports for connection to internal and/or external targets. Each initiator port may have a single physical link (e.g., a narrow port) or two, four, or eight physical links (e.g., a wide port). In a SAS domain, initiators 110 may comprise Serial SCSI Protocol (SSP), Serial ATA Tunneling Protocol (STP), and/or Serial Management Protocol (SMP) initiator ports. The initiators 110 may generally function to originate processing requests for targets 112 and/or to receive responses from the targets. More specifically, initiators 110 may originate device-service and task-management requests for processing by targets 112, and receive responses for the same requests from the targets. Depending on the implementation, initiators 110 may be connected directly to targets 112 or indirectly via expander 102. Such connection may be made via, e.g., physical links consisting of two wire pairs connecting the transmitter of a PHY in one device (e.g., the initiator 110) to the receiver of a PHY in another device (e.g., the expander 102).

The targets 112 may be, for example, end devices such as storage drives such as SAS hard disk drives, serial ATA (SATA) hard disk drives, solid state disks (SSD), JBODs, or SAS tape drives. The targets 112 may include logical units and target ports that receive device service and task management requests for processing and send responses for the same to initiators 110. As mentioned, depending on the implementation, targets 112 may be connected directly to initiators 110 or indirectly via expander 102.

The expander 102 may be, for example, a SAS expander. The expander 102 may form part of the service delivery subsystem and facilitate communication between initiators 110, targets 112, and/or other expanders 102 (not shown). More particularly, expander 102 may establish connections between initiators 110, targets 112, and/or other expanders 102 by receiving commands and data in one port and routing them to another port based on the address (e.g., SAS address) of targets 112.

The expander 102 may use direct, table, and/or subtractive routing processes. The direct routing may be used to forward commands and/or data to targets directly attached to the expander 102. The table routing may be used to forward commands and/or data to another expander 102. The subtractive routing may be used to forward commands and/or data which the expander does not recognize to another expander 102 which does recognize the information.

The expander 102 may include a storage management module 104. Depending on the implementation, storage management module 104 may be implemented in hardware, software, or a combination of both For example, storage management module 104 may comprise instructions executable by a processing device (e.g., a SEP) to cause expander 102 to perform functionality discussed herein. Alternatively or in addition, storage management module 104 may comprise a hardware equivalent such as an application specific integrated circuit (ASIC), a logic device (e.g., PLD, CPLD, FPGA, PLA, PAL, GAL, etc.), or combination thereof.

The expander 102 includes expander functionality module 106 which includes functionality to control the operation of expander 102. For example, expander functionality module 106 can be implemented in software and may comprise instructions executable by a processing device to cause expander 102 to perform functionality discussed herein The expander functionality module 106 may include firmware to control operation of at least a portion of expander 102. In one example, initiators 110 can send expander 102 a new version or an update of expander functionality module 106 and cause the expander to load and execute the new or updated functionality module 106. In this manner, the functionality of expander 102 can be upgraded or updated to include new firmware with new features, firmware to address problems with the previous version of the module and the like.

The expander 102 includes zone configuration rules 108 which include a list of assignments to associate initiators 110 with targets 112 and to control access including allowing or restricting access of initiators to targets. For example, zone configuration rules 108 can specify that initiator 110-1 can access storage drives (1 through 6) of target 112-1 but restrict access to storage drives (7 through 12) of target 112-1. That is, if initiator 110-1 sends to expander 102 a request to access storage drives (1 through 6) of target 112-1, then storage management module 104 will allow initiator 110-1 access to storage drives (1 through 6) of target 112-1 including authorization to read from these specific storage drives and write to these specific storage drives. On the other hand, if initiator 110-1 sends to expander 102 a request to access storage drives (7 through 12) of target 112-1 then storage management module 104 will prevent initiator 110-1 access to storage drives (7 through 12) of target 112-1 which means that initiator 110-1 does not have authorization to read from these specific storage drives and write to these specific storage drives. The zone configuration rules 108 can be dynamically updated or set by external devices such as initiators 110.

As explained above, there may be instances where it may be desirable to update expander functionality module 106 of expander 102. For example, it may be desirable to update functionality of expander 102 to include firmware to implement new features, firmware to fix problems with the previous version of the module and the like. The SAS Protocol Layer (SPL) specification Revision 07, section 4.6.8 describes a feature called expander device reduced functionality. The expander 102 can be configured to support the expander reduced functionality mode and to allow initiators 110 to update functionality module 106 of the expander. This feature effectively allows for non-disruptive update of functionality module 106 of expander 102 and other devices. However, once expander 102 completes or exits the expander reduced functionality mode, it may be possible for multiple initiators 110 to gain unauthorized access to targets 112 such as storage devices and corrupt storage drive meta-data and other data, potentially causing data loss. For example, in a zoning environment where multiple initiators 110 share access to a storage enclosure with targets 112 having storage devices, there may he a window of time where previous zoning configuration rules 108 can be violated because expander 102 may not automatically reapply or reconfigure the zoning configuration rules after exiting the expander reduced functionality mode. This may cause data corruption or data loss if the initiators are modifying data on storage drives they are not authorized to access. That is, the process for updating the expander functionality module 106 of expander 102 may disrupt the zoning of targets 112 coupled to the expander such that initiators 110 may gain unauthorized access to targets.

The storage management module 104 can be configured to implement expander reduced functionality mode and allow dynamic zoning of targets 112 to initiators 110 but prevent the initiators from accessing the targets coupled to the expander when the expander functionality module 106 of the expander is in the process of being updated. In one example, storage management module 104 is configured to configure zoning of targets 112 coupled to expander 102 based on zone configuration rules 108. The storage management module 104 can be configured to cause, in response to receipt of a command to enter an expander reduced functionality mode of operation, the expander to prevent initiators 110 access to targets 112 coupled to the expander and to allow update of expander functionality module 106 for controlling operation of the expander. For example, initiator 110-1 can be designated to send a command to enter an expander reduced functionality mode of operation, as shown by arrow 107 in FIG. 1. It should be understood that initiator 110-1 is shown as an example initiator to send the command and that any other initiator can be designated to send the command. The storage management module 104 can be configured to cause, upon completion of the expander reduced functionality mode of operation, expander 102 to reconfigure the zoning of targets 112 coupled to the expander based on the zone configuration rules 108 and to allow initiators 110 with access to targets 112 coupled to the expander.

In this manner, the present application provides techniques to implement expander reduced functionality mode and allow dynamic zoning of targets to initiators but prevent initiators from accessing the targets coupled to the expander when the expander functionality module of the expander is in the process of being updated.

The system 100 of FIG. 1 shows an example SAS fabric and it should be understood that other configurations can be employed to practice the techniques of the present application. For example, system 100 can be configured to include a switch-expander device (which itself can include expanders) coupled between initiators and other expanders which in turn are coupled to targets. In another example, the components of system 100 can be integrated in one enclosure or a plurality of enclosures located in one location or distributed over remote locations.

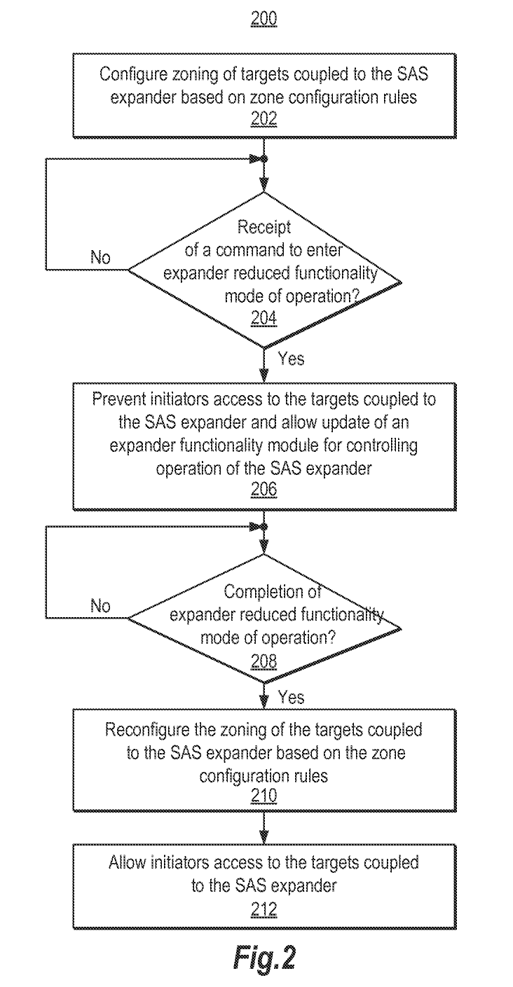

FIG. 2 depicts an example flow chart 200 of a process conducted by an expander in accordance with an example of the techniques of present application. In some implementations, such process 200 is conducted by the previously-mentioned storage management module 104. It should be readily apparent that the process depicted in FIG. 2 represent generalized illustrations, and that other processes may be added or existing processes may he removed, modified, or rearranged without departing from the scope and spirit of the present application. In addition, it should be understood that the processes may represent instructions stored on a processor-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with an expander. Furthermore, the flow charts are not intended to limit the implementation of the present application, but rather the flow charts illustrate functional information that one skilled in the art could use to design/fabricate circuits, generate software, or use a combination of hardware and software to perform the illustrated processes.

The process 200 may begin at block 202, where storage management module 104 configures zoning of targets 112 coupled to SAS expander 102 based on zone configuration rules 108. The zone configuration rules 103 which includes a list of assignments to associate initiators 110 with targets 112 and to control access including allowing or restricting access of initiators to targets. In one example, to illustrate, zone configuration rules 108 can specify that initiator 110-1 can access storage drives (1 through 6) of target 112-1 but restrict access to storage drives (7 through 12) of target 112-1. That is, if initiator 110-1 sends to expander 102 a request to access storage drives (1 through 6) of target 112-1 then storage management module 104 will allow initiator 110-1 access to storage drives (1 through 6) of target 112-1. On the other hand, if initiator 110-1 sends to expander 102 a request to access storage drives (7 through 12) of target 112-1, then storage management module 104 will prevent initiator 110-1 access to storage drives (7 through 12) of target 112-1. The zone configuration rules 108 can be dynamically updated or set by an external device such as an initiator 110-1 or other device.

At block 204, storage management module 104 checks for receipt of a command to enter an expander reduced functionality mode of operation. For example, initiator 110-1 can be designated to send a command to enter an expander reduced functionality mode of operation, as shown by arrow 107 in FIG. 1. It should be understood that initiator 110-1 is shown as an example initiator to send the command and that any other initiator can be designated to send the command. In one example, initiators 110 can send SAS or SSP WRITE_BUFFER commands or SAS or SSP RESET commands to request that expander 102 enter the expander reduced functionality mode of operation. If storage management module 104 does not receive the command, then processing proceeds back to block 204 to have the storage management module continue checking for receipt of the command. On the other hand, if storage management module 104 receives the command, then processing proceeds to block 206 as described below.

At block 206, storage management module 104 prevents initiators 110 access to targets 112 coupled to SAS expander 102 and allows update of an expander functionality module 106 for controlling operation of the SAS expander. In one example, upon entering the expander reduced functionality mode of operation, storage management module 104 is configured to send a SAS BROADCAST primitive to initiators to indicate that expander 104 has entered the expander reduced functionality mode of operation, in one example, in response to the SAS BROADCAST primitives sent by storage management module 104, the storage management module can receive SAS or SMP DISCOVER commands from initiators 110. In response to the SAS or SMP DISCOVER commands from initiators 110, storage management module 104 can send to the initiators messages with information related to the status of expander 102. The SAS or SMP DISCOVER commands are part of the SAS discovery process in which devices connected to the SAS fabric can be alerted of changes to other devices in the fabric. In response, as part of the discovery process, the devices can request information of other devices in the fabric to determine changes in the topology of the fabric. For example, the devices can discover whether other devices have been added or deleted in the topology or that features of devices have changed. In another example, the device configuration parameters may have changed such as device link changes, device speed changes and the like. In this manner, initiators 110 can be informed of the current functionality of expander 102 and to allow the initiators to adapt to the changes in expander.

The initiators 110 may continue to communicate with expander 102 and send to the expander requests or command to access targets 112 and the like. Since expander is in the expander reduced functionality mode of operation and updating expander functionality module, it is desirable to prevent initiators 110 with access to targets 112 during this time. In one example, to prevent initiators 110 access to targets 112, storage management module 104 can respond to connection commands from initiators by preventing establishment of connections and responding to the commands with SAS RETRY messages such as OPEN_REJECT (RETRY) primitives. That is, storage management module 104 is not removing itself from the topology, but rather simply preventing or restricting access to targets coupled to expander 102.

In one example, to update expander functionality module 106, storage management module 104 can be configured to receive from initiator 110 a load command that includes expander functionality module 106 with firmware to control operation of at least a portion of expander 102, and to receive an activate command to cause the expander to load and execute the functionality module. The load command can cause storage management module 104 to receive from initiator portions of functionality module 106 over a period of time and then load the received portions into expander, such as memory of the expander, until it has received all of the portions. Once the functionality module 106 has been loaded into expander 102, the activate command can cause storage management module 104 to execute a reboot process which can cause the new received functionality module 106 to be executed and cause the zoning of initiators and targets to be reset or erased. For example, initiator 110-1 can be designated to send to expander 102 a command to include expander functionality module 106 and cause the expander to load and execute the module, as shown by arrow 107 in FIG. 1. In one example, the load and activate commands can comprise SAS or SSP WRITE_BUFFER commands. The SAS based primitives may include data structures in accordance with the SAS protocol or specification and comprise low level 4 byte sequences communicated or exchanged between connections or links between expanders and devices. In contrast, SAS based commands may include additional requirements such as multiple frames and other communication overhead.

At block 208, storage management module 104 checks for completion of the expander reduced functionality mode of operation. If storage management module 104 has not completed the expander reduced functionality mode of operation, then processing proceeds back to block 208 to continue with the expander reduced functionality mode of operation. For example, storage management module 104 may still be in the process of loading or updating functionality module 106 including still in the process of rebooting with the new functionality module. On the other hand, if storage management module 104 completes the expander reduced functionality mode of operation, then processing proceeds to block 210 as described below. For example, storage management module 104 may have completed the process of updating functionality module 106 including completion of the process of rebooting with the new functionality module.

At block 210, storage management module 104 reconfigures the zoning of targets 112 coupled to SAS expander 102 based on the zone configuration rules 108. As explained above, in one example, to illustrate, zone configuration rules 108 specified that initiator 110-1 can access storage drives (1 through 6) of target 112-1 hut restrict access to storage drives (7 through 12) of target 112-1. During the expander reduced functionality mode of operation and process to update functionality module 106, the zoning of initiators 110 to targets 112 using zone configuration rules 108 was reset or erased. At this point, storage management module 104 can reconfigure or reapply the previous zone configuration rules 108 which specified that initiator 110-1 can access storage drives (1 through 6) of target 112-1 but restrict access to storage drives (7 through 12) of target 112-1. In this manner, storage management module 104 can preserve the previous zoning of initiators 110 to targets 112 that was set before the execution of the process of updating expander functionality module 106.

Al block 212, storage management module 104 allows initiators 110 access to targets 112 coupled to SAS expander 102. In one example, wherein upon completion of the expander reduced functionality mode of operation, storage management module 104 can send SAS BROADCAST primitives to initiators 110 to indicate that expander 102 has completed the expander reduced functionality mode of operation. In one example, in response to the SAS BROADCAST primitives sent by storage management module 104, the storage management module can receive SAS or SMP DISCOVER commands from initiators 110. In response to the SAS or SMP DISCOVER commands from initiators 110, storage management module 104 can send to the initiators messages with information related to the update of expander functionality module 106. The SAS DISCOVER commands are part of the SAS discovery process in which devices connected to the SAS fabric can be alerted of changes of devices in the fabric. In response, as part of the discovery process, the devices can request information of other devices in the fabric to determine changes in the topology of the fabric. For example, the devices can discover that devices have been added or deleted in the topology or that features of devices have changed. In another example, the device configuration parameters may have changed such as device link changes, device speed changes and the like. In this manner, initiators 110 can be informed of the current functionality of expander 102 and to allow the initiators to adapt to the changes in expander. For example, expander 102 may have been updated to include a new feature and the new feature can be included as part of the information in messages that is sent initiators so that they can recognize and perhaps adapt to the new features.

At this point, storage management module 104 can preserve the previous zoning of initiators 110 to targets 112 that was set before the process of updating expander functionality module 106. That is, initiator 110-1 can access storage drives (1 through 6) of target 112-1 but is not allowed access to storage drives (7 through 12) of target 112-1.

In this manner, the present application provides techniques to implement expander reduced functionality mode and allow dynamic zoning of targets to initiators but prevent initiators from accessing the targets coupled to the expander when the expander functionality module of the expander is in the process of being updated.

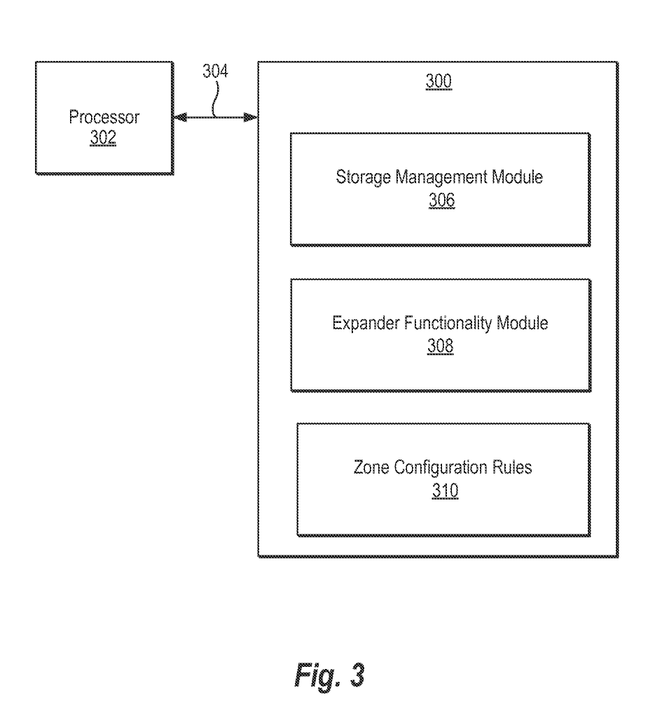

FIG. 3 is an example block diagram showing a non-transitory, computer-readable medium that stores code for operating an expander. The non-transitory, computer-readable medium is generally referred to by the reference number 300 and may be included in storage management module 104 described in relation to FIG. 1. The non-transitory, computer-readable medium 300 may correspond to any typical storage device that stores computer-implemented instructions, such as programming code or the like. For example, the non-transitory, computer-readable medium 300 may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical drives, and flash memory devices.

A processor 302 generally retrieves and executes the instructions stored in the non-transitory, computer-readable medium 300 to operate an expander in accordance with an example. In an example, the tangible, machine-readable medium 300 can be accessed by the processor 302 over a bus 304. A first region 306 of the non-transitory, computer-readable medium 300 may include storage management module functionality as described herein. A second region 308 of the non-transitory, computer-readable medium 300 may include expander functionality module as described herein. A third region 310 of the non-transitory, computer-readable medium 300 may include zone configuration rules as described herein.

Although shown as contiguous blocks, the software components can be stored in any order or configuration. For example, if the non-transitory, computer-readable medium 300 is a hard drive, the software components can be stored in non-contiguous, or even overlapping, sectors

The foregoing describes a novel and previously unforeseen approach to allow dynamic zoning of targets to initiators but prevent initiators from accessing the targets coupled to the expander when the expander functionality module of the expander is updated. While the above application has been shown and described with reference to the foregoing examples, it should be understood that other forms, details, and implementations may be made without departing from the spirit and scope of the application that is defined in the following claims.

What is claimed is:

1. A SAS expander, comprising:
a storage management module to cause the SAS expander to:
configure zoning of targets coupled to the SAS expander based on zone configuration rules;
in response to receipt of a command to enter an expander reduced functionality mode of operation, the SAS expander to prevent initiators access to the targets coupled to the SAS expander, and to allow update of an expander functionality module for controlling operation of the SAS expander; and
upon completion of the expander reduced functionality mode of operation, the SAS expander to reconfigure the zoning of the targets coupled to the SAS expander based on the zone configuration rules and to allow initiators access to the targets coupled to the SAS expander.

2. The SAS expander of claim 1, wherein when in the expander reduced functionality mode of operation, the SAS expander configured to receive from an initiator a load command that includes the expander functionality module with firmware to control operation of at least a portion of the SAS expander, and to receive an activate command to cause the SAS expander to load and execute the functionality module.

3. The SAS expander of claim 1, wherein upon entering the expander reduced functionality mode of operation, the SAS expander configured to send a SAS BROADCAST primitive to initiators coupled to a SAS fabric to indicate that the SAS expander has entered the expander reduced functionality mode of operation.

4. The SAS expander of claim 1 wherein upon completion of the expander reduced functionality mode of operation, the SAS expander configured to send a SAS BROADCAST primitive to initiators coupled to a SAS fabric to indicate that the SAS expander has completed the expander reduced functionality mode of operation.

5. The SAS expander of claim 1, wherein upon completion of the expander reduced functionality mode of operation, in response to the SAS expander receiving a DISCOVER command from an initiator coupled to a SAS fabric, the SAS expander configured to send a message with information related to the update of expander functionality module.

6. The SAS expander of claim 1, wherein during the expander reduced functionality mode of operation, in response to a connection command from an initiator coupled to a SAS fabric, the SAS expander configured to prevent establishment of a connection and respond to the command with a RETRY message.

7. The SAS expander of claim 1, wherein the zone configuration rules include a list of assignments to associate initiators with targets and to control access including allow or restricting access of initiators to targets.

8. A method of operating a SAS expander, comprising:
configuring, by a SAS expander, zoning of targets coupled to the SAS expander based on zone configuration rules;
in response to receipt of a command to enter an expander reduced functionality mode of operation, allowing, by the SAS expander, prevent initiators access to the targets coupled to the SAS expander and update an expander functionality module for controlling operation of the SAS expander; and
upon completion of the expander reduced functionality mode of operation, reconfiguring, by the SAS expander, the zoning of the targets coupled to the SAS expander based on the zone configuration rules and to allow initiators access to the targets coupled to the SAS expander.

9. The method of claim 8, wherein when in the expander reduced functionality mode of operation, further comprising receiving from an initiator a load command that includes the expander functionality module with firmware to control operation of at least a portion of the SAS expander, and receiving an activate command to cause the SAS expander to load and execute the expander functionality module.

10. The method of claim 8, wherein upon entering the expander reduced functionality mode of operation, further comprising sending a SAS BROADCAST primitive to initiators coupled to a SAS fabric to indicate that the SAS expander has entered the expander reduced functionality mode of operation.

11. The method of claim 8, wherein upon completion of the expander reduced functionality mode of operation, further comprising sending a SAS BROADCAST primitive to initiators coupled to a SAS fabric to indicate that the SAS expander has completed the expander reduced functionality mode of operation.

12. The method of claim 8, wherein upon completion of the expander reduced functionality mode of operation, in response to the SAS expander receiving a DISCOVER command from an initiator coupled to a SAS fabric, further comprising sending a message with information related to the update functionality.

13. The method of claim 8, wherein during the expander reduced functionality mode of operation, in response to a connection command from an initiator coupled to a SAS fabric, further comprising preventing establishment of a connection and responding to the command with a RETRY message.

14. The method of claim 8, wherein the zone configuration rules include a list of assignments to associate initiators with targets and to control access including allow or restricting access of initiators to targets.

15. A non-transitory computer-readable medium having computer executable instructions stored thereon to operate a SAS expander, the instruction are executable by a processor to:
configure zoning of targets coupled to the SAS expander based on zone configuration rules;
in response to receipt of a command to enter an expander reduced functionality mode of operation, prevent initiators access to the targets coupled to the SAS expander and to allow update of an expander functionality module for controlling operation of the SAS expander; and
upon completion of the expander reduced functionality mode of operation, reconfigure the zoning of the targets coupled to the SAS expander based on the zone configuration rules and to allow initiators access to the targets coupled to the SAS expander.

16. The non-transitory computer-readable medium of claim 15, further comprising instructions that if executed cause a processor to: wherein when in the expander reduced functionality mode of operation, receive from an initiator a load command that includes the expander functionality module with firmware to control operation of at least a portion of the SAS expander, and receiving an activate command to cause the SAS expander to load and execute the expander functionality module.

17. The non-transitory computer-readable medium of claim 15 further comprising instructions that if executed cause a processor to: wherein upon entering the expander reduced functionality mode of operation, send a SAS BROADCAST primitive to initiators coupled to a SAS fabric to indicate that the SAS expander has entered the expander reduced functionality mode of operation.

18. The non-transitory computer-readable medium of claim 15 further comprising instructions that if executed cause a processor to: wherein upon completion of the expander reduced functionality mode of operation, send a SAS BROADCAST primitive to initiators coupled to a SAS fabric to indicate that the SAS expander has completed the expander reduced functionality mode of operation.

19. The non-transitory computer-readable medium of claim 15 further comprising instructions that if executed cause a processor to: wherein upon completion of the expander reduced functionality mode of operation, in response to the SAS expander receiving a DISCOVER command from an initiator coupled to a SAS fabric, send a message with information related to the update of the expander functionality module.

20. The non-transitory computer-readable medium of claim 15 further comprising instructions that if executed cause a processor to: the zone configuration rules include a list of assignments to associate initiators with targets and to control access including allow or restricting access of initiators to targets.
